(19) United States
(12) Patent Application Publication
(10) Pub. No.: US 2003/0154022 A1
(43) Pub. Date: Aug. 14, 2003

(54) Navigation apparatus and navigation method

(76) Inventor: Atsushi Tanabe, Tokyo (JP)

Correspondence Address: BIRCH STEWART KOLASCH & BIRCH, PO BOX 747, FALLS CHURCH, VA, 22040-0747, US

(21) Appl. No.: 10/336,830

(22) Filed: Jan. 6, 2003

(30) Foreign Application Priority Data
Feb. 13, 2002 (JP) 2002-035876

(51) Int. Cl. G01C 21/34

(52) U.S. Cl. 701/209; 701/211; 340/990

(57) ABSTRACT

A navigation apparatus includes a current position determination unit for determining the current position of a vehicle, a storage unit for storing map data, a route searching unit for searching for a route from the current position of the vehicle determined by the current position determination unit to a destination by referring to the map data stored in the storage unit, a screen producing unit for listing points that are targets for guidance and are located on the route searched for by the route searching unit, and for producing a route list screen for providing information about the points, the route list screen including the name and number of a road associated with each of the points, and a display unit for displaying the route list screen produced by the screen producing unit.

### BACKGROUND OF THE INVENTION

1. Field of the Invention

The present invention relates to a navigation apparatus for and a navigation method of guiding users along a route to a destination.

2. Description of Related Art

When displaying a route guidance screen showing a route from a current position of a vehicle to a destination, if the names of roads on the route are registered therein, prior art navigation apparatuses can display the names of the roads on the route. When the names of the roads on the route are not registered, prior art navigation apparatuses can display a number given to each of the roads on the route instead. Japanese patent application publication (TOKKAIHEI) No. 4-316200 discloses a prior art navigation apparatus that displays a name given to each of the roads on the route.

A problem with prior art navigation apparatuses constructed as mentioned above is that because the names of roads on a route are displayed on a priority basis, it is difficult for users to keep track of the route along which the vehicle should be headed in a case where they can recognize the numbers of the roads on the route more easily than their names. Particularly, when the vehicle approaches a branch point to a road in which signs having only a number given to the road are posted along the road, it is difficult for users to keep track of the route if only the road's name is displayed on the navigation apparatus.

### SUMMARY OF THE INVENTION

The present invention is proposed to solve the above-mentioned problems, and it is therefore an object of the present invention to provide a navigation apparatus and a navigation method that enable users to easily recognize a route to a destination.

In accordance with an aspect of the present invention, there is provided a navigation apparatus including a route searching unit for searching for a route from the current position of a vehicle determined by a current position determination unit to a destination by referring to map data stored in a storage unit, a screen producing unit for listing points that are targets for guidance and are located on the route searched for by the route searching unit, and for producing a route list screen for providing information about the points, the route list screen including the name and number of a road associated with each of the points, and a display unit for displaying the route list screen produced by the screen producing unit. Therefore, the present invention provides an advantage of being able to enable users to easily recognize the route.

In accordance with another aspect of the present invention, there is provided a navigation apparatus including a route searching unit for searching for a route from the current position of a vehicle determined by a current position determination unit to a destination by referring to map data stored in a storage unit, a screen producing unit for producing a route guidance screen for providing the route searched for by the route searching unit and the current position of the vehicle, the route guidance screen including a name and number of a road on the route, and a display unit for displaying the route guidance screen produced by the screen producing unit. Therefore, the present invention provides an advantage of being able to enable users to easily recognize the route.

In accordance with a further aspect of the present invention, there is provided a navigation method including the steps of searching for a route from the determined current position of a vehicle to a destination by referring to map data, listing points that are targets for guidance and are located on the route, producing a route list screen for providing information about the points, the route list screen including a name and number of a road associated with each of the points, and displaying the produced route list screen. Therefore, the present invention provides an advantage of being able to enable users to easily recognize the route.

In accordance with another aspect of the present invention, there is provided a navigation method comprising the steps of searching for a route from the determined current position of a vehicle to a destination by referring to map data, producing a route guidance screen for providing the route and the current position of the vehicle, the route guidance screen including a name and number of a road on the route, and displaying the produced route guidance screen. Therefore, the present invention provides an advantage of being able to enable users to easily recognize the route.

Further objects and advantages of the present invention will be apparent from the following description of the preferred embodiments of the invention as illustrated in the accompanying drawings.

### BRIEF DESCRIPTION OF THE DRAWINGS

FIG. 1 is a block diagram showing the structure of a navigation apparatus according to embodiment 1 of the present invention;

FIG. 2 is a flow chart showing a navigation method according to embodiment 1 of the present invention;

FIG. 3 is an explanatory drawing for showing a route list screen;

FIG. 4 is an explanatory drawing for showing a route guidance screen; and

FIG. 5 is an explanatory drawing for showing a data configuration of a map disk.

### DETAILED DESCRIPTION OF THE PREFERRED EMBODIMENTS

The invention will now be described with reference to the accompanying drawings.

Embodiment 1.

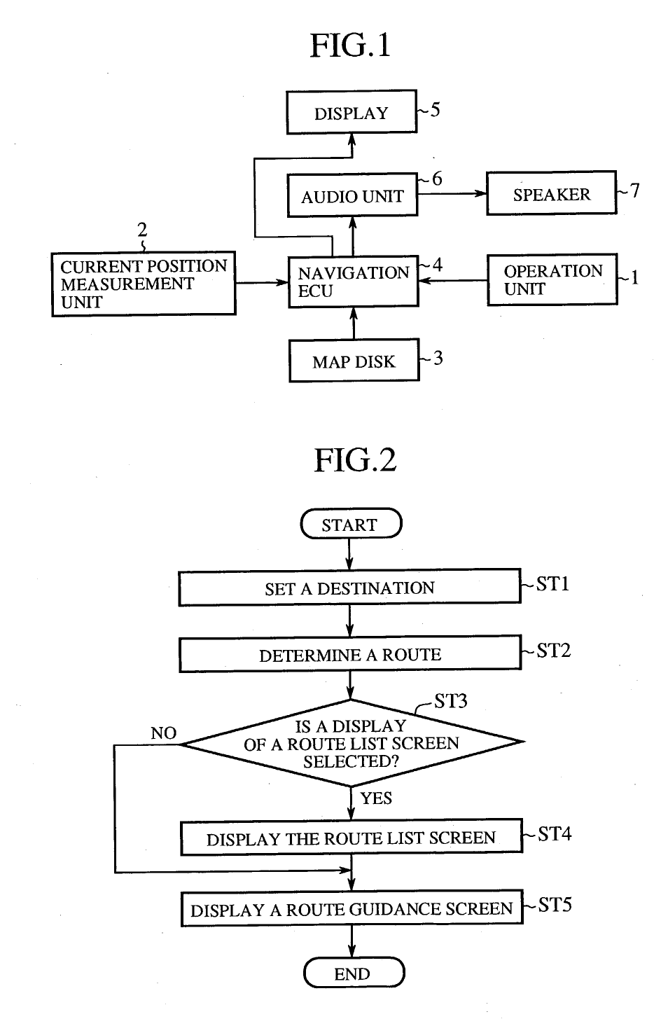

FIG. 1 is a block diagram showing the structure of a navigation apparatus according to embodiment 1 of the present invention. In the figure, reference numeral 1 denotes an operation unit for allowing-users to set a destination and for allowing users to switch between display screens, reference numeral 2 denotes a current position determination unit (current position determination means), in which a GPS receiver, a vehicle speed sensor, and so on are installed, for example, for determining the current position of a vehicle equipped with the navigation apparatus, and reference numeral 3 denotes a map disk (storage means) for storing map data, and for storing data (for example, intersection's name, intersection configuration, and data on connected roads connected to each intersection or interchange (road type, road's name, and route number)) about points that are targets for guidance, such as intersections, interchanges and so on.

Reference numeral 4 denotes a navigation ECU (route searching means, screen producing means, and display means) having a route searching function of searching for a route from the current position of the vehicle to the destination, a screen producing function of listing points that are targets for guidance and are located on the route searched for by using the route searching function, producing a route list screen for providing information about the points for users, and producing a route guidance screen for showing the route searched for by the route searching function and the current position of the vehicle, and a display function of displaying the route list screen and the route guidance screen on a display (display means) 5, reference numeral 6 denotes an audio unit (voice output means) for outputting a voice indicating a direction of travel in which the vehicle should be headed when the vehicle reaches each intersection that is a target for guidance under control of the navigation ECU 4, for example, and reference numeral 7 denotes a speaker (voice output means). FIG. 2 is a flow chart showing a navigation method according to the embodiment 1 of the present invention.

Next, a description will be made as to an operation of the navigation apparatus. First of all, when the current position determination unit 2 determines the current position of the vehicle by referring to GPS data from the GPS receiver, for example, and a user operates the operation unit 1 in order to set a destination (in step ST1), the navigation ECU 4 searches for a route from the current position of the vehicle to the destination under preset searching conditions (for example, the navigation ECU 4 searches for a route having the shortest travel time, the shortest distance, the highest vehicle speed, or the like) (in step ST2).

When the user desires a display of the route list screen (the screen for providing information about points that are targets for guidance), the user can make a request for a display of the route list screen by operating the operation unit 1. When the user makes a request for a display of the route list screen (in step ST3), the navigation ECU 4 lists points that are targets for guidance and are located on the route previously searched for thereby. The navigation ECU 4 then produces the route list screen for providing information about the points that are targets for guidance and displays the route list screen on the display 5 (in step ST4).

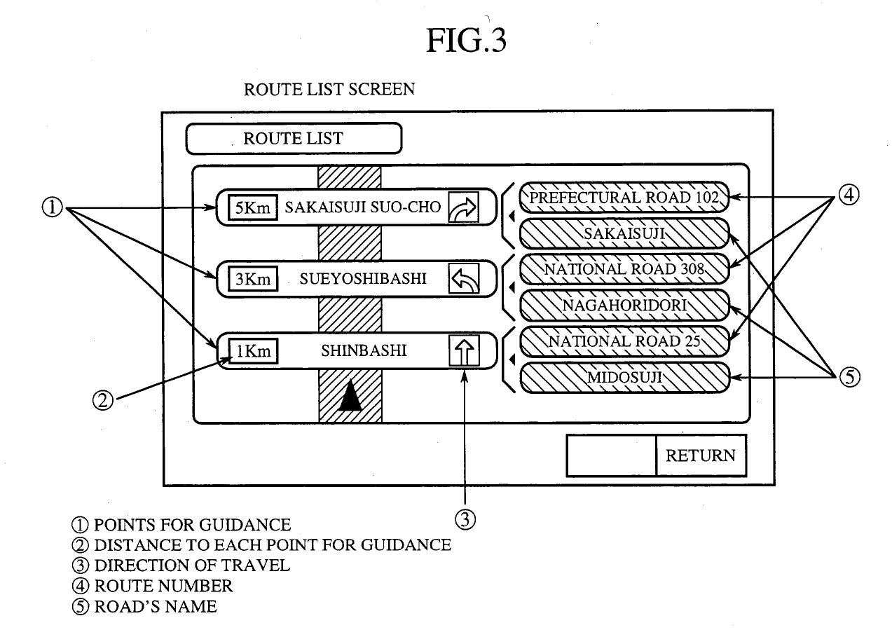

The navigation ECU 4 produces the route list screen so that the route list screen includes the names and route numbers of roads on the route along which the vehicle should travel, the name and route number of each road indicating a direction of travel in which the vehicle should be headed at a corresponding point on the route that is a target for guidance, as shown in FIG. 3. In the case of FIG. 3, for example, for the point “Sueyoshibashi” that is a second target for guidance, the route list screen indicates a left turn and shows that that the name of the road along which the vehicle should travel after making a left turn is “Nagahoridori” and the route number is “National road No. 308”.

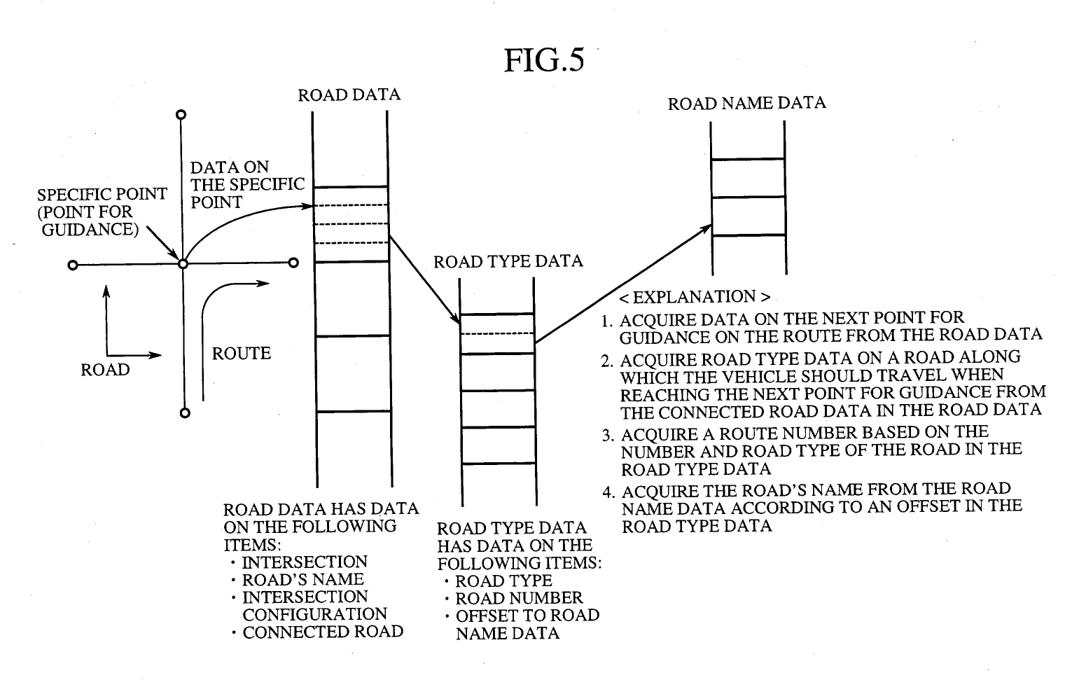

Because data on points that are targets for guidance are compiled into a database on the map disk 3, as shown in FIG. 5, the navigation ECU 4 acquires road type data on road types by referring to connected road data on connected roads connected to each of the listed points that are targets for guidance and are running in a direction of travel in which the vehicle should be headed by acquiring road data on roads associated with the listed points. The navigation ECU 4 then determines the route number of a road along which the vehicle should travel when reaching each of the listed point that is a target for guidance from the road type of the road (for example, national road or prefectural road) included in the road type data and the road number given to the road (for example, No. 102 or No. 308). The navigation ECU 4 further acquires the road name data on the road's name by referring to an offset to the road name data included in the road type data so as to determine the road's name.

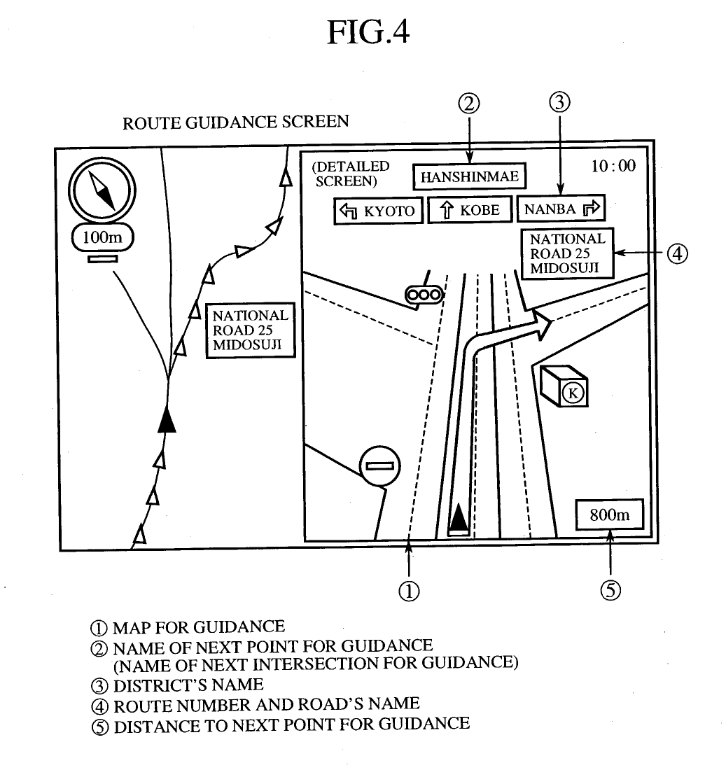

After that, when the user desires a display of the route guidance screen and operates the operation unit 1, the navigation ECU 4 produces the route guidance screen for providing the route previously searched for thereby and the current position of the vehicle, and then displays the route guidance screen on the display 5 (in step ST5). In this case, the navigation ECU 4 produces the route guidance screen so that the route guidance screen includes, for each of the listed points that is a target for guidance and is located on the route, the name and route number of a road along which the vehicle should travel when reaching each of the listed points, the road's name and route number indicating a direction of travel in which the vehicle should be headed, as shown in FIG. 4. The method of acquiring the road's name and route number is implemented as mentioned above.

When determining that the vehicle approaches the next point that is the next target for guidance and is located on the route (for example, when determining that the distance from the current position of the vehicle to the next point becomes equal to or less than 100 meters), the navigation ECU 4 produces a detailed route guidance screen associated with the next point. In this case, the navigation ECU 4 produces the detailed route guidance screen so that the detailed route guidance screen includes the name and route number of a road along which the vehicle should travel when reaching the next point, the road's name and route number indicating a direction of travel in which the vehicle should be headed, as shown in FIG. 4. In the example of FIG. 4, the detailed route guidance screen shows that at “Hanshinmae” that is the next point, the user is instructed to make a right turn, and the name of the road along which the vehicle should travel after making a right turn is “Midosuji” and the route number is “National road No. 25”.

As previously mentioned, in accordance with this embodiment 1 of the present invention, because the navigation apparatus produces a route guidance screen so that the route guidance screen includes, for each of listed points that is a target for guidance and is located on the route, the name and route number of a road along which the vehicle should travel, the road's name and route number indicating a direction of travel in which the vehicle should be headed when reaching each of the listed points on the route, users can easily recognize the road along which the vehicle should travel when reaching each of the listed points on the route.

Numerous variants can be made in the exemplary embodiment mentioned above. In accordance with a variant, under control of the navigation ECU 4, the audio unit 6 can output the name and route number of a road on the route along which the vehicle should travel by voice every time when the vehicle approaches each of the listed points that is a target for guidance and is located on the route, the road's name and route number indicating a direction of travel in which the vehicle should be headed. As a result, users can easily recognize the road along which the vehicle should travel when reaching each of the listed points on the route without having to see neither the route list screen nor the route guidance screen.

In accordance with another variant, a popular or common name such as “oyafuko (undutifulness to one's parents)-dori” can be used as the name of each road included in the route list screen or route guide screen.

Many widely different embodiments of the present invention may be constructed without departing from the spirit and scope of the present invention. It should be understood that the present invention is not limited to the specific embodiments described in the specification, except as defined in the appended claims.

What is claimed is:

1. A navigation apparatus comprising: a current position determination means for determining a current position of a vehicle; a storage means for storing map data; a route searching means for searching for a route from the current position of the vehicle determined by said current position determination means to a destination by referring to the map data stored in said storage means; a screen producing means for listing points that are targets for guidance and are located on the route searched for by said route searching means, and for producing a route list screen for providing information about the points, the route list screen including a name and number of a road associated with each of the points; and a display means for displaying the route list screen produced by said screen producing means.

2. The navigation apparatus according to claim 1, wherein said screen producing means produces the route list screen so that the route list screen includes, for each of the points on the route, the name and number of a road which indicate a direction of travel in which the vehicle should be headed when reaching each of the points.

3. The navigation apparatus according to claim 1, wherein said screen producing means uses a popular or common name as the road's name.

4. A navigation apparatus comprising: a current position determination means for determining a current position of a vehicle; a storage means for storing map data; a route searching means for searching for a route from the current position of the vehicle determined by said current position determination means to a destination by referring to the map data stored in said storage means; a screen producing means for producing a route guidance screen for providing the route searched for by said route searching means and the current position of the vehicle, the route guidance screen including a name and number of a road on the route; and a display means for displaying the route guidance screen produced by said screen producing means.

5. The navigation apparatus according to claim 4, wherein said screen producing means produces the route guidance screen so that the route list screen includes, for each of points that are targets for guidance and are located on the route, the name and number of a road which indicate a direction of travel in which the vehicle should be headed when reaching each of the points.

6. The navigation apparatus according to claim 4, wherein when said navigation apparatus determines that the vehicle approaches to each of the points, said screen producing means produces a detailed route guidance screen so that the detailed route guidance screen includes the name and number of a road which indicate a direction of travel in which the vehicle should be headed when reaching each of the points.

7. The navigation apparatus according to claim 4, further comprising a voice outputting means for outputting the name and number of a road which indicate a direction of travel in which the vehicle should be headed when reaching each of the points by voice every time when the vehicle approaches each of the points.

8. The navigation apparatus according to claim 4, wherein said screen producing means uses a popular or common name as the road's name.

9. A navigation method comprising the steps of: determining a current position of a vehicle; searching for a route from the determined current position of the vehicle to a destination by referring to map data; listing points that are targets for guidance and are located on the route; producing a route list screen for providing information about the points, the route list screen including a name and number of a road associated with each of the points; and displaying the produced route list screen.

10. A navigation method comprising the steps of: determining a current position of a vehicle; searching for a route from the determined current position of the vehicle to a destination by referring to map data; producing a route guidance screen for providing the route and the current position of the vehicle, the route guidance screen including a name and number of a road on the route; and displaying the produced route guidance screen.
